(19) United States
(12) Patent Application Publication
(10) Pub. No.: US 2013/0136426 A1
(43) Pub. Date: May 30, 2013

(54) WEB FEED BASED RECORDING SCHEDULE

(71) Applicants: Alan Merzon, San Jose, CA (US); Tim Herby, Los Altos, CA (US); Antonio Fontan, San Jose, CA (US)

(72) Inventors: Alan Merzon, San Jose, CA (US); Tim Herby, Los Altos, CA (US); Antonio Fontan, San Jose, CA (US)

(73) Assignee: MICROSOFT CORPORATION, Redmond, WA (US)

(21) Appl. No.: 13/305,605

(22) Filed: Nov. 28, 2011

(51) Int. Cl. H04N 5/76

(52) U.S. Cl. 386/296; 386/E05.003

(57) ABSTRACT

According to one aspect of this disclosure, a request is received to add content items indicated by a third-party web feed to a recording schedule. One or more of the content items indicated by the third-party web feed may be automatically added to the recording schedule. The recording schedule may indicate content items to be recorded by an electronic content recording device from a content provider.

### BACKGROUND

Watching television and movie programs can be a social experience. People often spend significant time and energy sharing thoughts and opinions related to television and movie programs. Typically, if a person hears of a potentially interesting program, that person can find that program on her own to view later. However, it can be difficult to remember the programs one hears about, and finding such programs may be laborious and time consuming.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of this disclosure, a request is received to add content items indicated by a third-party web feed to a recording schedule. One or more of the content items indicated by the third-party web feed may be automatically added to the recording schedule. The recording schedule may indicate content items to be recorded by an electronic content recording device from a content provider.

### BRIEF DESCRIPTION OF THE DRAWINGS

FIG. 1 schematically shows an example system for managing recording schedules.

FIG. 2 shows an example method for managing recording schedules.

FIG. 3 schematically shows a first instance of a web feed.

FIG. 4a schematically shows a recording schedule before modification according to the method of FIG. 2.

FIG. 4b schematically shows the recording schedule of FIG. 4a after modification according to the method of FIG. 2.

FIG. 5 schematically shows a second instance of the web feed of FIG. 3.

FIG. 6a schematically shows the recording schedule of FIG. 4b before further modification according to the method of FIG. 2.

FIG. 6b schematically shows the recording schedule of FIG. 6a after further modification according to the method of FIG. 2.

FIG. 7 shows an example computing system for performing the method of FIG. 2.

### DETAILED DESCRIPTION

The present description is related to automatically recording content items, such as television shows, movies, or webcasts, for example. In particular, the present description is related to methods for choosing content items to be added to a recording schedule. As one example, a user may subscribe to a web feed so that all content items identified in the web feed are added to a recording schedule and automatically recorded. The web feed may be published by virtually anyone. The web feed may be updated periodically, so that new content items added to the web feed are also automatically recorded.

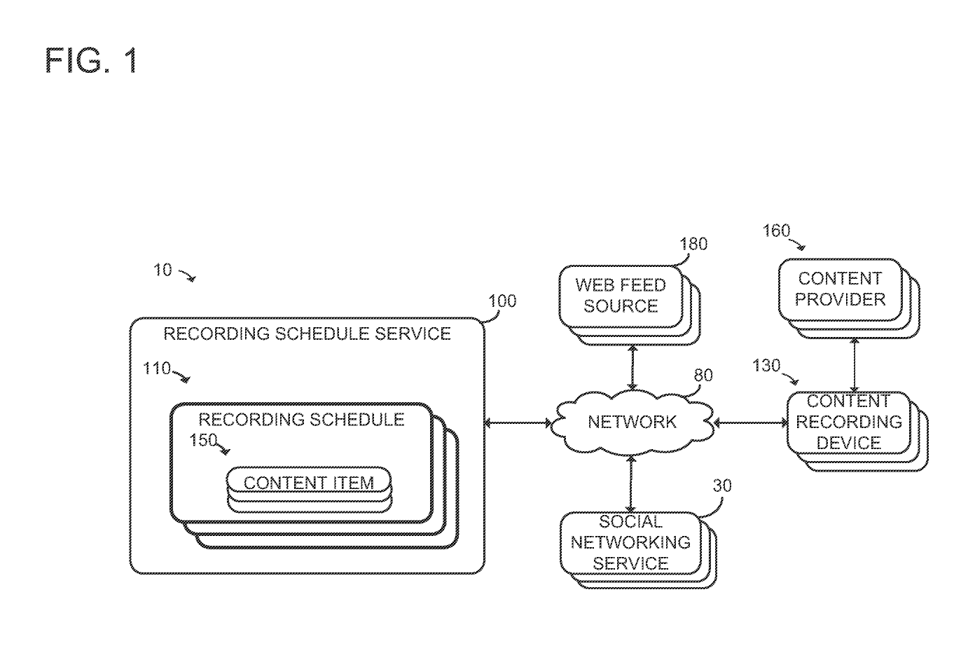

FIG. 1 schematically shows a system 10 for creating and using recording schedules 110. System 10 includes content recording devices 130, recording schedule service 100, social networking services 30, content providers 160, and web feed sources 180, which may share information via a network 80, such as the Internet. In some embodiments, one or more of the above listed elements may be integrated together in a common service or device. For example, recording schedule service 100 may be integrated as part of content recording device 130,

Content recording devices 130 are configured to receive and record content items 150 from content providers 160. A content item 150 may include virtually any audio-visual content, such as a television show, a webcast, a radio show, streaming video, or a movie, for example. The content items 150 may be delivered to content recording devices 130 via any suitable transmission mechanism, including but not limited to over-the-air broadcasts, cable broadcasts, satellite broadcasts, and/or Internet broadcasts. Content providers 160 may provide such content items for free, as part of a subscription package, on an ‘on demand’ basis, or via virtually any other distribution model. It should be appreciated that the content items may be received from more than one content provider. In some embodiments, a content item 150 may include a pointer that indicates a location where an item of audio-visual content is located. The pointers may be accessed at time of playback to retrieve the content on an “on-demand” basis.

Recording schedules 110 may be used to indicate to content recording devices 130 which content items 150 are to be recorded. Recording schedules 110 may be associated with a particular content recording device 130 and/or a particular user profile. Thus, it is possible to add a content item 150 to a recording schedule 110 so that a particular content recording device 130 will record that content item, or so that more than one content recording device 130 associated with the same user profile will record that content item. It is to be appreciated that recording schedules 110 may contain an indication of content items 150 to be recorded rather than actual content items. Thus, a content item is “added” to a recording schedule by adding an indicator of that content item.

Recording schedule service 100 may maintain, create, and/or modify recording schedules 110. Recording schedule service 100 may have read and/or write access to recording schedules for a plurality of devices and/or users, or may have read and/or write access to recording schedules for only the device on which it is located. Recording information from a first user may be used to create, modify and/or maintain a recording schedule of a second user.

Social networking services 30 may include one or more services that are capable of recognizing a virtual identity of a user (e.g., a user profile) and the social connections of that user (e.g., friend profiles). Social networking services 30 may be utilized by recording schedule service 100. For example, the recording schedule may receive and/or share user information with one or more social networking service via an application programming interface (API) or other suitable mechanism. Social networking service 30 may share virtually any user information, such as recording/viewing habits of a user or a user's social graph, for example. In some embodiments, social networking service 30 may be configured to show which content items a user wishes to share with others. In some embodiments, recording schedule service 100 may be combined with one or more social networking services.

In some embodiments, content items 150 may be automatically added to a recording schedule 110 according to a web feed. The web feed may be accessible via web feed sources 180, or via Social networking services 30, for example. Web feed sources may include virtually any network accessible source capable of syndicating information related to content items. World Wide Web sites and services, e-mail services, social networking services, and data transfer services are nonlimiting examples of web feed sources 180.

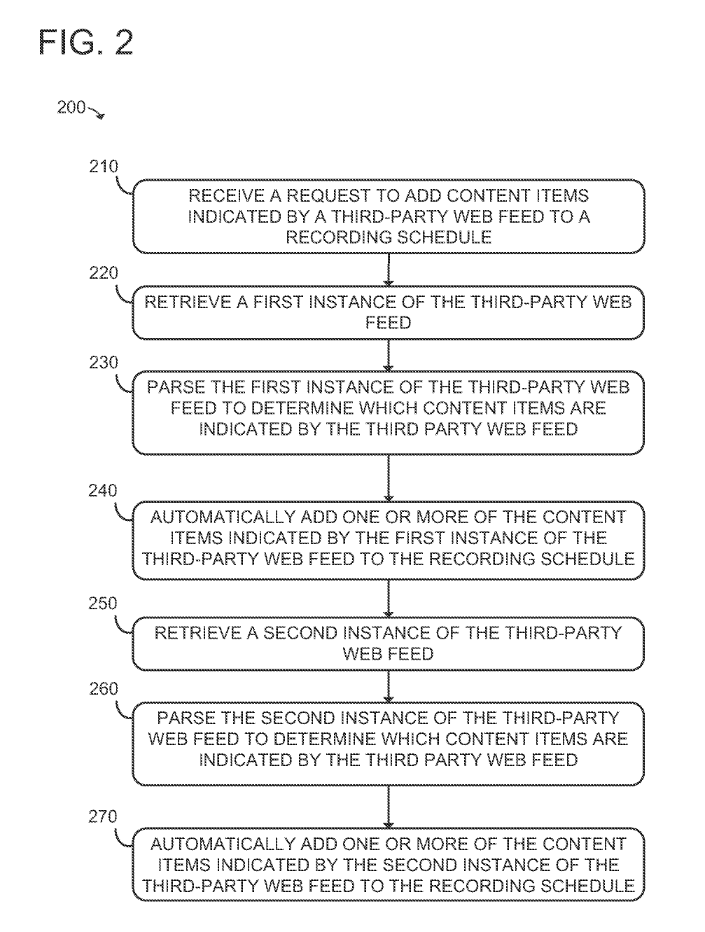

FIG. 2 shows an example method 200 for automatically adding content items to a recording schedule. Method 200 may be performed by recording schedule service 100 or content recording device 130, for example. At 210, the method 200 includes receiving a request to add content items indicated by a third-party web feed to a recording schedule. As used herein, a web feed may be any suitable syndicated content to which a user can subscribe. Nonlimiting examples of suitable web feeds include Resource Description Framework Site Summary (RSS) web feeds and Atom Syndication Format (Atom) web feeds.

The term third-party web feed is used herein to describe a web feed that is published by an entity other than the user. The third party may be virtually anyone without departing from the scope of this disclosure.

Web feeds may be received from virtually anywhere, such as a web log (blog), a social networking service, a personal website, or in an e-mail, for example. In some embodiments, web feeds are received from a ‘web feed store’. Such a web feed store may provide a common place from which web feeds can be received. A web feed store may have a plurality of web feeds indexed and cataloged for easy searching by a user. The web feed store may show featured web feeds. A web feed store may organize web feeds by popularity, genre, content, or web feed author, for example. The user may utilize a user interface to request web feeds organized via the web feed store.

The request to add content items indicated by the third-party web feed may be received via network 80 of FIG. 1, for example. In some embodiments, a user may activate a hyperlink to initiate the request. For example, a user may navigate to a web site associated with a published web feed. The user may activate a hyperlink to request that any content items indicated by the third-party web feed are added to a recording schedule of the user. In response to activating the hyperlink, the web site may send recording schedule service 100 and/or content recording device 130 information for retrieving the web feed so that the web feed may be subsequently retrieved. It is to be understood that the above example is nonlimiting, and that other requests for adding content items may be used without departing from the scope of this disclosure.

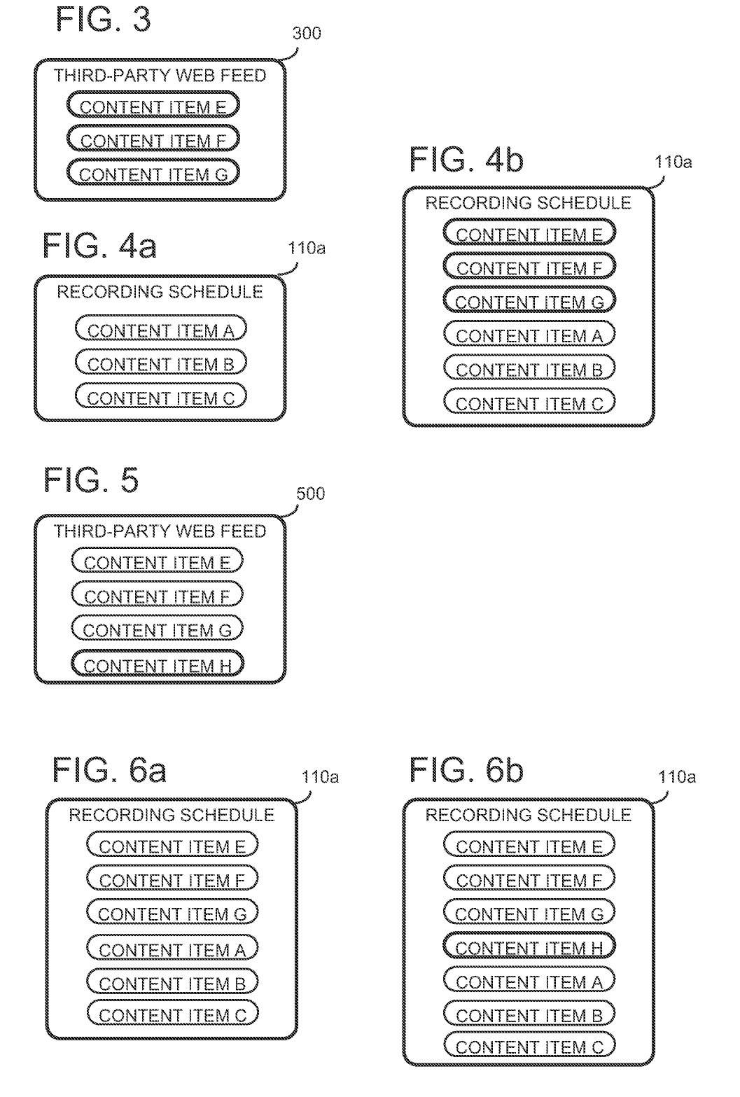

In response to receiving the request, the method 200 may include, at 220, retrieving a first instance of the third-party web feed. A first instance of the third-party web feed may be retrieved using any suitable mechanism for retrieving web feeds. An example first instance 300 of a third-party web feed is shown at FIG. 3. As shown, first instance 300 indicates content items E, F, and G. These content items may be indicated by the first instance 300 via metadata associated with that content item. Such metadata may include virtually any combination of information related to the content item that uniquely identifies the content item, such as a broadcast time, the content provider, a genre of the content item, and/or other information that may identify that content item, for example. In some embodiments, third-party web feeds include one or more universal identification codes to uniquely identify the content item independent of the content provider.

The third-party web feed may be retrieved from the same location (e.g. a web site) that sent the request. However, it should be appreciated that the third-party web feed may be retrieved from a location other than the location that sent the request. For example, a hyperlink on a first webpage may provide access to a web feed provided at a second webpage. The request may be made via the first webpage, and the corresponding web feed may be retrieved from the second webpage. The request may include instructions for locating the third-party web feed.

Turning back to FIG.2, the method 200 may include, at 230, parsing the first instance of the third-party web feed to determine which content items are indicated by the first instance of the third-party web feed. In some embodiments, the web feed is a preformatted web feed published in a specific format to facilitate determining which content items are indicated. For example, the web feed may be formatted using an extensible markup language, and an identification code for each recommended content item may be contained within an “identification code” element of the extensible markup language. In such a case, parsing includes extracting the identification code from the predetermined portion of the web feed.

A tool may be utilized to publish web feeds in the predefined format. For example, an online computing application may provide a user with a list of content items that they may wish to add to a web feed. The user may use the online computing application to select a set of content items. The application may then publish a preformatted web feed indicating those content items.

In some embodiments, the third-party web feed is designed for a purpose other than indicating content items to be added to a recording schedule, such as for human reading. However, the web feed may still be parsed to determine content items to be added to a recording schedule. For example, an author may publish a blog about her favorite TV shows, and parsing may include extracting information from the blog to determine which content items she recommends. As one example, if a person types positive words about a particular content item, it may be determined that that person recommends that content item. As such, method 200 may be utilized even if a universal identification code is not included in the web feed and/or if the web feed is not preformatted in a purpose specific manner for the sole purpose of signaling which content items should be added to a recording schedule.

If the identification code is not included in the web feed itself, other information may be utilized to find identification codes. Such information may include a genre, start time, an associated content provider, a content item length, and/or virtually any other extracted information or combination of extracted information that may be used to identify the content item. For example, parsing may include determining, from a web page, that a content item is titled ‘News Hour’ and starts at 5:30 EST on channel ABC. This information may be checked against a database of start times, titles, and/or channels to find a corresponding identification code.

The method 200 may include, at 240, automatically adding one or more of the content items indicated by the first instance of the third-party web feed to the recording schedule. Turning to FIG. 4a, FIG. 4a shows recording schedule 110a before any content items have been automatically added. FIG. 4b shows recording schedule 110a, after content items E, F, and G have been added, based on the first instance 300 of the third-party web feed of FIG. 3 which indicates content items E, F and G.

In some embodiments, not all of the content items indicated by the third-party web feed are added to a recording schedule. Adding may include adding a subset of the indicated content items. The subset may include preferred content items, and exclude non-preferred content items. Users may indicate which content items they prefer via settings, for example. One setting may indicate that content items with particular ratings (e.g. R, NC-17, TV-MA) are non-preferred content items. Thus, any content items with those ratings will not be added to a recording schedule. Other settings may indicate that high-definition content items are preferred, or content items in a particular language are preferred, for example. Virtually any preferences may be used to customize the types of content items that are to be added to a recording schedule. Similarly, virtually any preferences may be used to customize the types of content items that will not be added to a recording schedule, regardless of what the web feed recommends. As such, preferences may allow the third-party web feed to be used as a list of candidate content items to be added, rather than an inflexible specification of certain content items.

In some embodiments, content items are only added to recording schedules if a content provider is available to provide that content item. For example, if a user does not have a subscription to a particular movie content provider, content items that are provided by that movie content provider are not added to that user's recording schedule unless they can be obtained from another provider.

Web feeds may be updated at virtually any interval. Specifically, new content items may be added to a web feed, and previously recommended content items may be removed from a web feed. It may be desirable to add the new content items to a recording schedule each time the web feed is updated. In this way, a user may subscribe to a web feed such that content items added to the web feed are automatically added to that user's recording schedule after the updated web feed is retrieved. Content items that have been previously recorded may be kept for later viewing, even if such items are removed from the web feed.

In some embodiments, if a new content item that is added to the user's recording schedule is a currently airing content item, e.g., a television program that is airing at the time the content item is added, the currently airing content item may not be immediately added, but a complete re-broadcast of the content item may be added. In another embodiment, if the new content item is currently airing, the remainder of the content item (e.g., the portion of the content item that has yet to air) can be immediately added but replaced with a complete re-broadcast of the content item when the re-broadcast becomes available at a later time.

Turning back to FIG. 2, the method 200 may include, at 250, retrieving a second instance of the third-party web feed. The second instance may have a different set of content items indicated than the first instance. The second instance may have an additional content item, an additional set of content items, or an entirely new set of content items. Turning briefly to FIG. 5, FIG. 5 shows an example second instance 500 of a third-party web feed. As shown, second instance 500 has one more content item (content item H) than first instance 300 shown in FIG. 3.

Turning back to FIG. 2, the method 200 may include, at 260, parsing the second instance of the third-party web feed to determine which content items are indicated by the second instance of the third-party web feed. Parsing the second instance may be performed as described above with respect to parsing the first instance.

The method 200 may include, at 270, automatically adding one or more of the content items indicated by the second instance of the third-party web feed to the recording schedule. Turning to FIG. 6a, FIG. 6a shows recording schedule 110a before adding any content items indicated by a second instance of a web feed. FIG. 6b shows recording schedule 110a after being modified according to method 200. In particular, additional content item H has been added to recording schedule 110a, as indicated by second instance 500.

In some embodiments, the above described methods and processes may be tied to a computing system including one or more computers. In particular, the methods and processes described herein may be implemented as a computer application, computer service, computer API, computer library, and/or other computer program product.

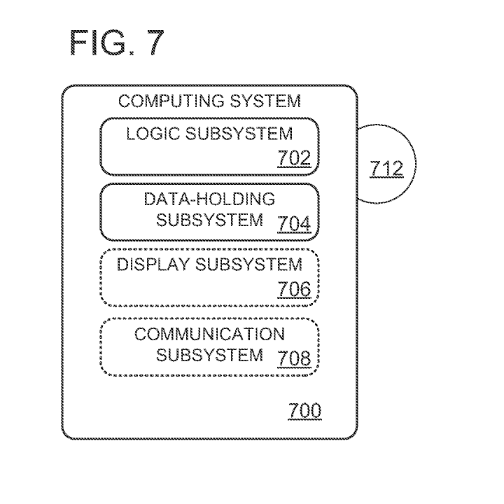

FIG. 7 schematically shows a nonlimiting computing system 700 that may perform one or more of the above described methods and processes. Computing system 700 is shown in simplified form. It is to be understood that virtually any computer architecture may be used without departing from the scope of this disclosure. In different embodiments, computing system 700 may take the form of a mainframe computer, server computer, desktop computer, laptop computer, tablet computer, home entertainment computer, network computing device, mobile computing device, mobile communication device, gaming device, etc.

Computing system 700 includes a logic subsystem 702 and a data-holding subsystem 704. Computing system 700 may optionally include a display subsystem 706, communication subsystem 708, and/or other components not shown in FIG. 7. Computing system 700 may also optionally include user input devices such as remote controls, keyboards, mice, game controllers, cameras, microphones, and/or touch screens, for example.

Logic subsystem 702 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 704 may include one or more physical, non-transitory, devices configured to hold data and/or instructions executable by the logic subsystem to implement the herein described methods and processes. When such methods and processes are implemented, the state of data-holding subsystem 704 may be transformed (e.g., to hold different data).

Data-holding subsystem 704 may include removable media and/or built-in devices. Data-holding subsystem 704 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 704 may include devices with one or more of the following characteristics: volatile, nonvolatile, dynamic, static, read/write, read-only, random access, sequential access, location addressable, file addressable, and content addressable. In some embodiments, logic subsystem 702 and data-holding subsystem 704 may be integrated into one or more common devices, such as an application specific integrated circuit or a system on a chip.

FIG. 7 also shows an aspect of the data-holding subsystem in the form of removable computer-readable storage media 712, which may be used to store and/or transfer data and/or instructions executable to implement the herein described methods and processes. Removable computer-readable storage media 712 may take the form of CDs, DVDs, HD-DVDs, Blu-Ray Discs, EEPROMs, and/or floppy disks, among others.

It is to be appreciated that data-holding subsystem 704 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 700 that is implemented to perform one or more particular functions. In some cases, such a module, program, or engine may be instantiated via logic subsystem 702 executing instructions held by data-holding subsystem 704. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 706 may be used to present a visual representation of data held by data-holding subsystem 704. As the herein described methods and processes change the data held by the data-holding subsystem, and thus transform the state of the data-holding subsystem, the state of display subsystem 706 may likewise be transformed to visually represent changes in the underlying data. Display subsystem 706 may include one or more display devices utilizing virtually any type of technology. Such display devices may be combined with logic subsystem 702 and/or data-holding subsystem 704 in a shared enclosure, or such display devices may be peripheral display devices.

When included, communication subsystem 708 may be configured to communicatively couple computing system 700 with one or more other computing devices. Communication subsystem 708 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 700 to send and/or receive messages to and/or from other devices via a network such as the Internet.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method for automatically adding content items to a recording schedule, the method comprising:
receiving a request to add content items indicated by a third-party web feed to a recording schedule; and
automatically adding one or more of the content items indicated by the third-party web feed to the recording schedule, the recording schedule indicating content items to be recorded by an electronic content recording device from a content provider.

2. The method of claim 1, where at least one content item is a television broadcast.

3. The method of claim 1, where at least one content item is streaming video.

4. The method of claim 1, where one or more content items are indicated by the third-party web feed via metadata associated with that content item.

5. The method of claim 4, where adding the content items includes parsing the metadata to find a universal identification code that is not included in the third-party web feed, the universal identification code uniquely identifying the content item independent of the content provider.

6. The method of claim 1, where the third-party web feed includes one or more universal identification codes to uniquely identify the content item independent of the content provider.

7. The method of claim 1, where adding includes adding a subset of the indicated content items, the subset including preferred content items and excluding non-preferred content items.

8. A method for automatically adding content items to a recording schedule, the method comprising:
receiving a request to add content items indicated by a third-party web feed to a recording schedule;
retrieving the third-party web feed;
parsing the third-party web feed to determine which content items are indicated by the third-party web feed; and
automatically adding one or more of the content items indicated by the third-party web feed to the recording schedule, the recording schedule indicating content items to be recorded by an electronic content recording device from a content provider.

9. The method of claim 8, where at least one content item is a television broadcast.

10. The method of claim 8, where at least one content item is streaming video.

11. The method of claim 8, where one or more content items are indicated by the third-party web feed via metadata associated with that content item.

12. The method of claim 8, where parsing the third-party web feed includes finding a universal identification code that is not included in the third-party web feed, the universal identification code uniquely identifying the content item independent of the content provider.

13. The method of claim 8, where the third-party web feed includes one or more universal identification codes to uniquely identify the content item independent of the content provider.

14. The method of claim 8, where adding the content items includes adding a subset of the indicated content items, the subset including preferred content items and excluding non-preferred content items.

15. A method for automatically adding content items to a recording schedule, the method comprising:
receiving a request to add content items indicated by a third-party web feed to a recording schedule, the third party web feed syndicated via a subscription service;
retrieving a first instance of the third-party web feed;
parsing the first instance of the third-party web feed to determine which content items are indicated by the first instance of the third-party web feed;
automatically adding one or more of the content items indicated by the first instance of the third-party web feed to the recording schedule, the recording schedule indicating content items to be recorded by an electronic content recording device from the provider of the television broadcast;
retrieving a second instance of the third-party web feed;
parsing the second instance of the third-party web feed to determine which content items are indicated by the second instance of the third-party web feed; and
automatically adding one or more of the content items indicated by the second instance of the third-party web feed to the recording schedule.

16. The method of claim 15, where at least one content item is a television broadcast.

17. The method of claim 15, where one or more content items are indicated by the third-party web feed via metadata associated with that content item.

18. The method of claim 15, where parsing the third-party web feed includes finding a universal identification code that is not included in the third-party web feed, the universal identification code uniquely identifying the content item independent of the content provider.

19. The method of claim 15, where the third-party web feed includes one or more universal identification codes to uniquely identify the content item independent of the content provider.

20. The method of claim 15, where adding the content items includes adding a subset of the indicated content items, the subset including preferred content items and excluding non-preferred content items.
